(19) United States
(12) Patent Application Publication
(10) Pub. No.: US 2008/0291021 A1
(43) Pub. Date: Nov. 27, 2008

(54) SYSTEM FOR PROVIDING THE STATUS OF A CONFERENCE ROOM AND METHOD OF USE

(75) Inventors: Kulvir S. Bhogal, Fort Worth, TX (US); Steven M. Miller, Cary, NC (US); Robert Peterson, Austin, TX (US); Lisa Anne Seacat, San Francisco, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/752,178

(22) Filed: May 22, 2007

(51) Int. Cl. G08B 13/14

(52) U.S. Cl. 340/572.1

(57) ABSTRACT

A method for determining availability of a conference room is disclosed. The method comprises transporting a mobile device into a conference room by a user wherein the conference room has an RFID tag, a conference room number, and is identified in a reservation system. The method further includes utilizing the mobile device to retrieve a conference room number by scanning the RFID tag within the conference room. Next, the mobile device is utilized to query the reservation system. The method further comprises determining whether the conference room is currently reserved. Next, the mobile device is utilized to alert the user if the reservation system indicates that the conference room is currently reserved.

### FIELD OF THE INVENTION

The present invention relates generally to conference rooms and in particular to a system for providing a status of a conference room to users.

### BACKGROUND OF THE INVENTION

Conference rooms are utilized for meetings in a variety of settings. Many conference rooms are reserved in a reservation system but are never utilized. These rooms could have been utilized by an individual or group of individuals who may need to use the room for an impromptu meeting for a brief time period.

An individual or a group of individuals may spontaneously seek out a conference room for an impromptu meeting without reserving the conference room. Oftentimes, the individual only needs to use a conference room for a brief amount of time, which makes scheduling a conference room a tedious task. Because a group may utilize an unreserved conference room, the group may be asked to vacate by those who have reserved the room or by those scheduled to attend a meeting within the room. The constant search, set up, removal, and re-set up into a new conference room is often troublesome to parties that only wish to utilize a conference room for a short period of time.

Thus, what is needed is a system and method that addresses the above-identified issues. The present invention addresses such a need.

### SUMMARY OF THE INVENTION

A method for determining availability of a conference room is disclosed. The method comprises transporting a mobile device into a conference room by a user, wherein the conference room has a RFID tag, a conference room number, and is identified in a reservation system. The method further includes utilizing the mobile device to retrieve a conference room number by scanning the RFID tag within the conference room. Next, the mobile device is utilized to query the reservation. The method further comprises determining whether the conference room is currently reserved. Next, the method further comprises utilizing the mobile device to alert the user if the reservation system indicates that the conference room is currently reserved.

### BRIEF DESCRIPTION OF SEVERAL VIEWS OF THE DRAWINGS

FIG. 1 shows a reservation system which includes a calendar that may be utilized within a reservation system of the present invention.

FIG. 2 shows a group of individuals that have entered a conference room equipped with a RFID tag identifying the conference room and a RFID scanner located on a wall therein.

FIG. 3 shows a flowchart for a method for determining availability of a conference room.

FIG. 4 shows a flowchart for a method for maximizing the efficiency of the use of conference rooms within the reservation system.

### DETAILED DESCRIPTION OF THE INVENTION

The present invention relates to a system and in particular, a system for providing an automated meeting room status detector. The following description is presented to enable one having ordinary skill in the art to make and use the embodiment and is provided in the context of a patent application and the generic principles and features described herein will be apparent to those skilled in the art. Thus, the present embodiment is not intended to be limited to the embodiments shown, but is to be accorded the widest scope consistent with the principles and features described herein.

A system and method in accordance with the present invention includes a reservation system for scheduling meeting venues such as conference rooms and the like. The reservation system may allow a user, such as a meeting organizer, to schedule one or more conference rooms within the system for a specified time period.

For example, a corporate office building may have many conference rooms for company employees to reserve and use for various meetings. An employee may utilize a calendar within the reservation system to reserve a specific conference room at a certain time period if the conference room is unreserved. The reservation system may be utilized and accessed by company employees, personnel, or members within corporate and non-corporate entities such as in public buildings, non-profit organizations and the like would be in the spirit and scope of the present invention.

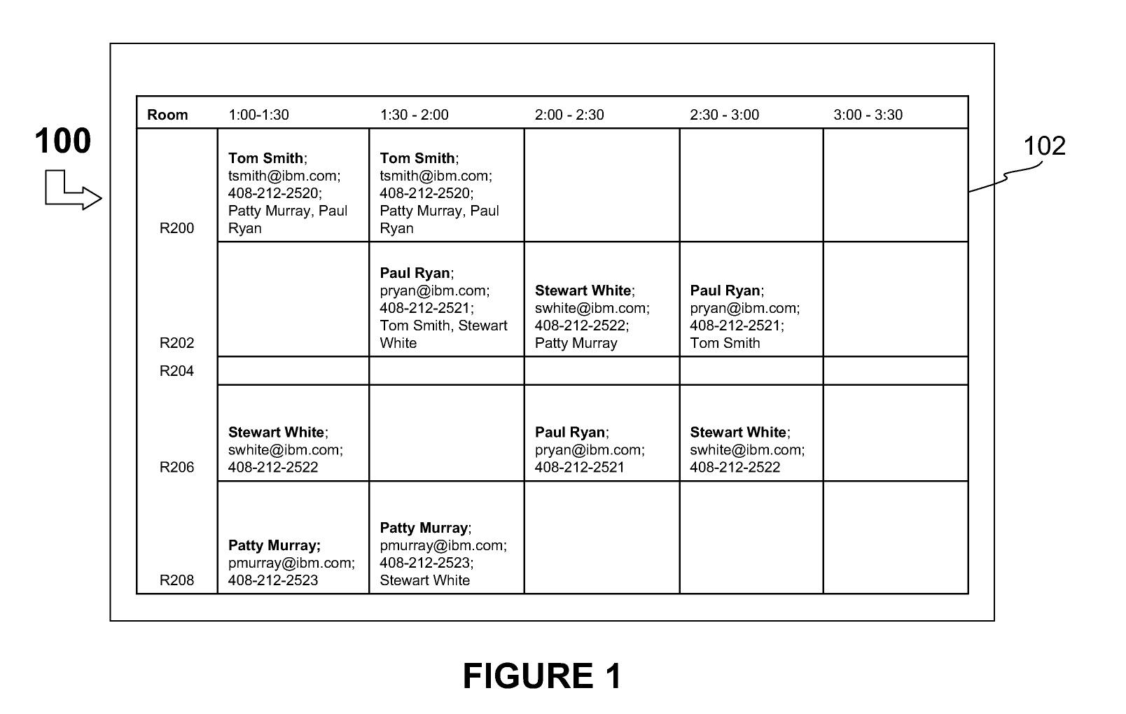

FIG. 1 shows, in one embodiment a reservation system 100 which includes a calendar 102. As shown, a list of rooms (R200, R202, R204, R206, and R208) is displayed alongside a column of time slots. For example, calendar 102 shows, by indication of a name of a meeting organizer, in bold along with contact information (email address and telephone number) of the meeting organizer and list of attendees in a row associated with each time slot, the reservation schedule of each room. For example, room R200 is shown to be reserved by Tom Smith from 1:00-1:30 and from 1:30 to 2:00. The attendees at the meeting are listed as Patty Murray and Paul Ryan. Room R202 is shown to be reserved by Paul Ryan from 1:30-2:00 and Tom Smith and Stewart White are listed to attend a meeting within room R202. Although, calendar 102 is illustrated within the reservation system 100, other calendars which feature more or less rooms, longer or shorter time periods, and the like would be in the spirit and scope of the present invention.

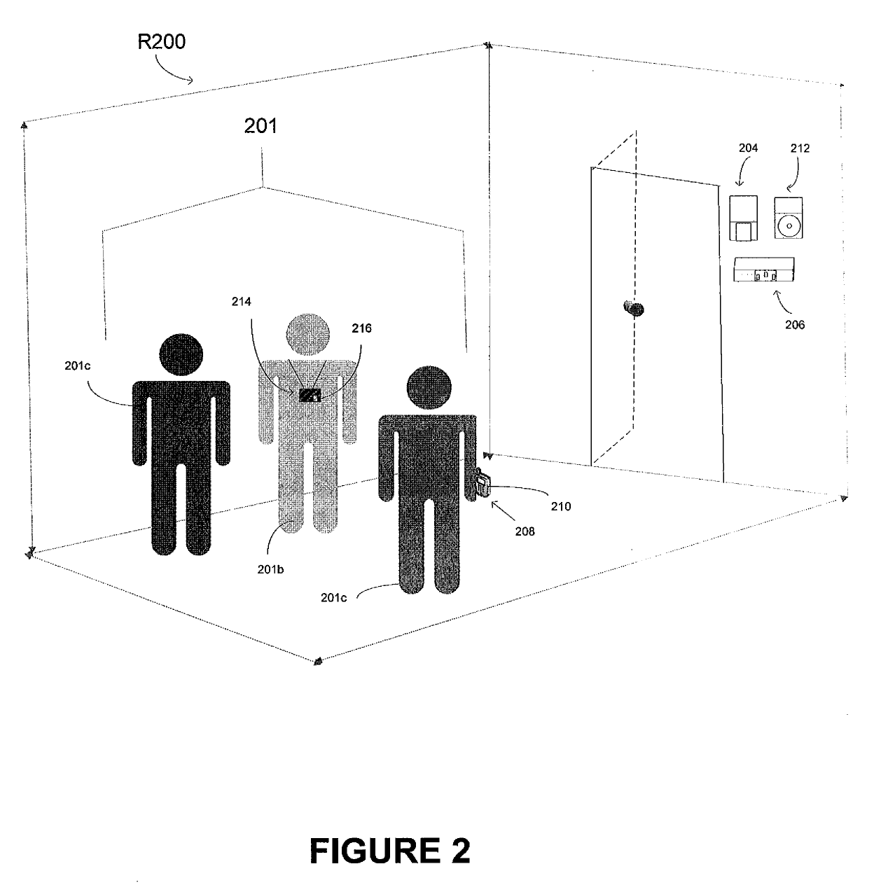

FIG. 2 shows a group 201 of individuals 201a, 201b, and 201c that have entered a conference room R200 equipped with a RFID tag 206 identifying the conference room R200 and a RFID scanner 204 located on a wall therein. The individuals 201a, 201b, and 201c may all transport into the room R200 mobile devices having RFID capability and a unique RFID tag. For example, individuals within group 201 may transport a mobile device such as a laptop computer, personal digital assistant, pager, cellular phone, or an employee badge into the conference room R200. As shown, one individual 201a of the group 201 has transported a cell phone 208 having RFID capability and a unique RFID tag 210 disposed thereon within the room R200. Another individual 201c is shown wearing an employee badge 214 having a RFID tag 216.

A system and method of the present invention may provide a reservation system 100 that provides two features: the first feature allows the system 100 to be queried by authorized personnel such as employees and the like for determining the availability of a conference room; and the second feature allows the system 100 to be utilized to maximize the efficiency of the use of conference rooms within the system 100, particularly when many of the rooms are presently reserved.

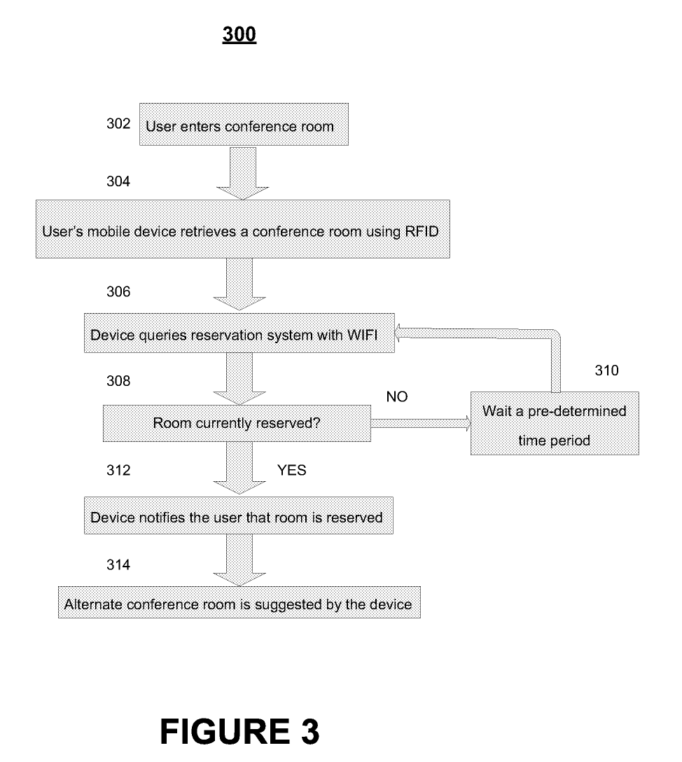

FIG. 3 shows a flowchart 300 for the first system 100 feature for determining an availability of a conference room.

Referring to FIGS. 2 and 3 together, the individual 201a may utilize his cell phone 208 wirelessly to access the reservation system 100 to check for the availability of conference room R200. The individual 201a enters the conference room R200, via step 302. Next, the individual 201a utilizes the cell phone 208 to retrieve the room number assigned to the conference room R200, via step 304.

Once the room R200 is identified, the individual 201a utilizes the cell phone 208 to query the reservation system 100 by a WIFI capability function of the cell phone 208, via step 306, to determine whether the room R200 is currently reserved in the system 100, via step 308.

If the system 100 determines that the room R200 is not reserved, the cell phone 208 waits a pre-determined time period, via step 310, and re-queries the reservation system 100 to determine whether the conference room R200 is currently reserved, via steps 306 and 308. The pre-determined frequency may be any time period including, but not limited to every five minutes, ten minutes, fifteen minutes, twenty minutes, etc. The time period would be in the spirit and scope of the present invention.

Once the reservation system 100 indicates that the conference room R200 is currently reserved, the cell phone 208 notifies the user (individual 201a), via step 312. For example, the system 100 may notify the user (individual 201a) by an audible, visual, or a vibrating alert, via step 312.

The individual 201a and group 201 may decide to either utilize the conference room R200 while running the risk of being removed there from by others that are scheduled to use the room R200. The cell phone 208 may also be configured to suggest an alternate, unreserved conference room, via step 314.

The reservation system 100 may indicate, however, that the room R200 is available and the individual 201a and group 201 may with ease choose to utilize the room R200 without potential distraction from others. The group 201 may also decide to reserve the room R200 within the reservation system 100 if the group 201 needs the room for a significant period of time.

The reservation system 100 may also be utilized to maximize the efficiency of the use of conference rooms within the system, particularly when many of the rooms are reserved. For example, the conference room R200 features a RFID scanner 204 and an infrared sensor 212 located on a wall within the room R200 to facilitate this function of system 100.

In an embodiment, the infrared sensor 212 may be utilized to recognize when individuals, such as group 201, enter the room R200. Once the infrared sensor 212 has recognized that the group 202 has entered the room R200, the RFID scanner 204 seeks to identify each individual 201a, 201b, and 201c by scanning the unique RFID tag coupled to the mobile devices (i.e. cell phone 208 and employee badge 214) transported into the room R200 by the group 201. In an embodiment, infrared sensor 212 first sends a signal to the RFID scanner 204 that the group 201 has entered the room R200 before the scanner 204 scans the room R200.

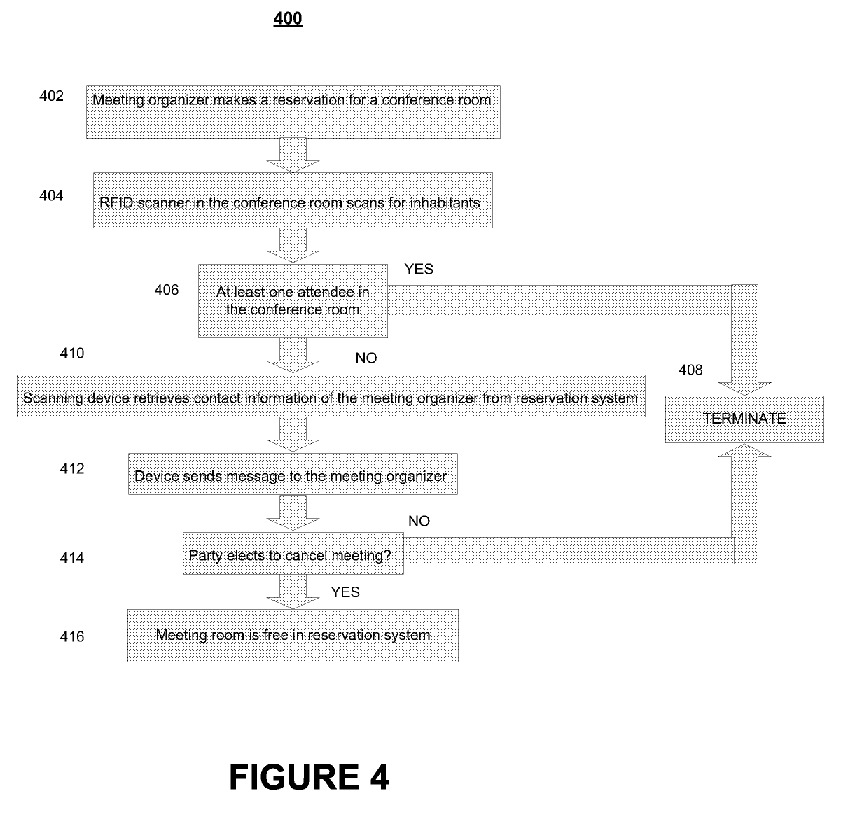

FIG. 4 shows a flowchart 400 for a method for maximizing the efficiency of the use of conference rooms within the reservation system 100.

Referring to FIGS. 2 and 4 together, the reservation system 100 may maximize the efficiency of the conference rooms within the system 100 accordingly. First, via step 402, a meeting organizer makes a reservation for conference room R200. The reservation system 100, associates a list of attendees with the room R200 at a specified time period for a meeting, both provided by the meeting organizer. Each attendee has a mobile device, such as cell phone 208 and employee badge 214, which has an unique RFID tag (i.e. tags 210 and 216). The room R200 has a RFID scanner 204 located on a wall within the room R200.

For example, FIG. 1 shows that Tom Smith is a meeting organizer that makes a reservation for Patty Murray and Doug Ryan to attend a meeting within the room R200 from 1:00-2:00 pm. Accordingly, the reservation system 100 associates Tom Smith, Patty Murray, and Doug Ryan with conference room R200 during the time period, 1:00-2:00 pm.

Next, the RFID scanner 204 is utilized to scan for each of the unique RFID tags of the attendees to search for the attendees (Tom Smith, Patty Murray, and Doug Ryan) scheduled to utilize the room at the specified time period for the meeting, via step 404. In an embodiment, the infrared sensor 212 sends a signal to the RFID scanner 204 when an individual has entered the room R200.

Next, via step 406, the system 100 determines if at least one of the attendees is present in the conference room R200 at the specified, reserved time period. If there is at least one attendee in the conference room R200 then the system 100 terminates via step 408.

However, If the RFID scanner 204 fails to identify at least one of the attendees in the conference room R200, the reservation system 100 retrieves contact information of the meeting organizer (Tom Smith) who made the reservation for the room R200 at the specified time period via step 410.

Next, via step 412, the reservation system 100 utilizes the retrieved contact information to send a message to the meeting organizer (Tom Smith) requesting a status of the meeting within the room R200.

Then, via step 414, the system 100 determines whether the meeting organizer (Tom Smith) wants to cancel the reservation of the room based upon the meeting organizer's response to the message. That is, the system 100 has interactive capability to allow a meeting organizer to converse with the system 100 even after the reservation is made. If the meeting organizer elects not to cancel the reservation of the room R200 based upon the meeting organizer's response to the message, the system 100 terminates, via step 408. Otherwise, if the meeting organizer (Tom Smith) elects to cancel the reservation of the room R200, via step 414, the system 100 then indicates that room R200 is unreserved and available for reservation, via step 416.

Thus, a method and system in accordance with the present invention is utilized to check an availability of a conference room within a reservation and also to maximize the efficiency of conference room utility within the system. As such, the conference rooms within the system are equipped with RFID scanners to determine if at least one of a list of attendees have entered the room during a pre-determined time period and also a RFID tag which properly identifies the room within the reservation system. Users of the system may have mobile devices with built-in wireless and RFID capability to check the availability of the room within the reservation system. The system also allows interactivity between a meeting organizer and a system to enable a meeting organizer to determine the status of a reserved room within the system.

Although the embodiments and examples have utilized RFID technology, other technologies could be utilized such as, but not limited to GPS technology, Bluetooth technology, WIFI, or the like and they would be in the spirit and scope of the present invention.

Although the present embodiment has been described in accordance with the embodiments shown, one having ordinary skill in the art will readily recognize that there could be variations to the embodiments and those variations would be within the spirit and scope of the present embodiment. Accordingly, many modifications may be made by one having ordinary skill in the art without departing from the spirit and scope of the appended claims.

What is claimed is:

1. A method for determining availability of a conference room comprising: transporting a mobile device into a conference room by a user, the conference room has a RFID tag, a conference room number, and is identified in a reservation system;
utilizing the mobile device to retrieve the conference room number by scanning the RFID tag within the conference room;
utilizing the mobile device to query the reservation system;
determining whether the conference room is currently reserved; and
utilizing the mobile device to alert the user if the reservation system indicates that the conference room is currently reserved.

2. The method of claim 1, further comprising utilizing the mobile device to identify an alternate conference room.

3. The method of claim 1, wherein alerting the user is any of the group comprising an audible alert, a visual alert, and a vibrating alert.

4. The method of claim 1, wherein the mobile device is any of the group comprising a cell phone, a pager, a personal digital assistant, a laptop computer, and an employee badge.

5. The method of claim 1, wherein the mobile device queries the reservation system via a WiFi capability of the mobile device.

6. A method for efficiently utilizing a conference room comprising:
utilizing a meeting organizer to make a reservation for a conference room, the conference room being identified in a reservation system and wherein the reservation system associates a list of attendees with the conference room at a specified time period for a meeting both provided by the meeting organizer and wherein each attendee has a mobile device which has an unique radio frequency identification (RFID) tag and wherein the conference room includes a RFID scanner;
utilizing the RFID scanner within the conference room to scan for each of the unique RFID tags of the attendees to search for the attendees scheduled to utilize the conference room at the specified time period for the meeting;
retrieving contact information of the meeting organizer when the RFID scanner fails to identify at least one of the attendees in the conference room;
utilizing the retrieved contact information to send a message to the meeting organizer that there are no attendees in the conference room via the RFID scanner to request a status of the meeting;
determining whether the meeting organizer wants to cancel the reservation based upon the meeting organizer's response to the message; and
canceling the reservation of the conference room if the meeting organizer so elects in response to the message.

7. The method of claim 6, further comprising, making the conference room available for a new reservation in the reservation system if the meeting organizer elects to cancel the meeting.

8. The method of claim 6, wherein the mobile device is any of the group comprising a cell phone, a pager, a personal digital assistant, a laptop computer, and an employee badge.
